(19) United States
(12) Patent Application Publication
(10) Pub. No.: US 2018/0156691 A1
(43) Pub. Date: Jun. 7, 2018

(54) BEARING ASSEMBLY INCLUDING OIL QUALITY SENSOR

(71) Applicant: Aktiebolaget SKF, Goteborg (SE)

(72) Inventors: Sven Ehrhardt, Koenigsberg (DE); Jens Graf, Schweinfurt (DE)

(21) Appl. No.: 15/369,030

(22) Filed: Dec. 5, 2016

(51) Int. Cl. G01M 13/04; F16C 19/38; F16C 41/00

(52) U.S. Cl. CPC G01M 13/04; F16C 19/386; B60B 27/001; F16C 2233/00; F16C 2326/02; F16C 41/00

(57) ABSTRACT

A wheel bearing assembly for a motor vehicle includes a housing having an interior, at least one bearing in the interior including a first bearing ring and a second bearing ring rotatably disposed relative to the first bearing ring, a plurality of rolling elements disposed between the first bearing ring and the second bearing ring, a lubricant in the housing interior in contact with at least a part of the at least one bearing, an axle connected to the at least one bearing, a sensor in the housing interior in contact with the lubricant, the sensor being configured to sense at least one property of the lubricant and to output a signal indicative of the at least one property of the lubricant, and a display unit outside the housing interior and in communication with the sensor, the display unit being configured to produce an output based on the signal.

### TECHNOLOGICAL FIELD

The present disclosure is directed to a bearing assembly, in particular a wheel bearing assembly for a motor vehicle, that includes at least one bearing and an axle in an enclosure that contains a lubricant.

### BACKGROUND

Bearing assemblies are frequently lubricated with oil or another suitable lubricant in order to ensure their optimal functioning. However, for certain applications the lubricant used must be regularly monitored and, when necessary, changed or exchanged. An exchange may be necessary, for example, if the lubricant breaks down or becomes contaminated with dirt or metal particles or the like. Particularly in the case of wheel bearing assemblies, especially wheel bearing assemblies for trucks, it is costly to determine the condition of the lubricant because the hub cover must be removed in order to access the lubricant. In some cases the hub cover, also called the hubcap, may be securely connected to the hub, for example, by screws. This is the case, for example, when the lubricant is located not only inside the bearing itself, but also in the hub and the hub cover. The lubricant is retained in the entire assembly by the fixed hub cover.

Furthermore, the decision regarding whether to change the lubricant is often made by visual inspection and is thus based on the experience of the inspecting mechanic.

### SUMMARY

It is therefore an aspect of the present disclosure to provide a bearing assembly that makes possible a simple and safe monitoring of the lubricant.

In the following discussion, a bearing assembly, in particular a wheel bearing assembly for a motor vehicle, is disclosed, which bearing assembly includes at least one bearing having a first bearing ring and a second bearing ring rotatably disposed relative to the first bearing ring and that also includes rolling elements between the bearing rings. A bearing interior is defined in the bearing assembly in the region of the rolling elements, and a lubricant is retained in the interior. The bearing assembly also includes an axle that is connected to the at least one bearing.

In order to enable simple and safe monitoring of the lubricant, the bearing assembly includes a sensor that contacts the lubricant at least periodically and that is configured to output, at least periodically, a signal indicative of at least one property of the lubricant. For example, the sensor may be configured to detect whether the lubricant has broken down and/or whether the lubricant contains contaminants such as metal particles. In this way it can be determined whether the lubricant needs to be changed/exchanged without disassembling the bearing assembly. The decision to exchange the lubricant is therefore no longer dependent on the subjective judgment of a responsible mechanic about the condition of the lubricant, but rather the time for exchanging the lubricant can be determined automatically by the sensor. The sensor can carry out the monitoring continuously or at certain time intervals. Alternatively the monitoring can also be initiated by a user, for example, by manually or otherwise selectively activating the sensor.

In order to provide information about the state of the lubricant without opening the bearing interior, that is, to provide an indication about the state of the lubricant at a location outside the bearing interior, a display unit is provided that is in communication with the sensor and that is configured to emit a signal to the outside of the bearing interior, which signal is indicative of a state of the at least one monitored property of the lubricant. The display unit can indicate whether or not the lubricant must or should be exchanged. Thus an observer will be able to determine without disassembling the bearing assembly whether a disassembly of the bearing assembly for exchanging the lubricant is necessary at all. The service life of the bearing assembly can thus be increased, since the lubricant can be continuously or regularly monitored and an indication regarding a problematic change or break down of the lubricant can immediately be provided and can thereafter be addressed by changing the lubricant. The amount of time during which a bearing assembly operates with a lubricant of a no longer sufficient quality can thus be reduced. On the other hand, the need to disassemble a bearing assembly to check the quality of the lubricant can be avoided, and thereafter the main time it will be necessary to disassemble the bearing assembly will be to change or exchange the lubricant. This reduces the wear caused by unnecessary disassembly of the bearing assembly.

According to one advantageous exemplary embodiment the axle includes a hub cover, and the hub cover partially defines the interior. The display unit and/or the sensor may be disposed on and/or in the hub cover. In this way the display of the monitoring state can be seen in a particularly simple manner. The display unit can receive from the sensor the current state of the lubricant in a wireless or wired manner. A wireless transmission can occur, for example, via a radio interface.

According to a further advantageous exemplary embodiment, the hub cover is fixedly attached to the axle, by screws, for example, and the body of lubricant comes into contact with an interior of the hub cover. This occurs, for example, in trucks. The hub cover in such cases is not only securely clamped to the axle, but is also semi-permanently fixed thereto with attachment devices such as screws. In this case the sensor can be provided in the hub cover in order to be in contact with the lubricant. The sensor can, for example, be fixedly secured to an interior of the hub cover, by adhesive, for example, and rotate with the hub cover when the hub cover rotates. The lubricant may only partially fill the hub cover such that, for example, a surface of the lubricant is located, at half the height of the hub cover. In this case the sensor could monitor the lubricant at periodic intervals, i.e., whenever during movement the hub cover is brought into contact with the lubricant and/or immersed into it.

Alternatively the sensor can be provided such that it is freely movable in the hub cover. Here due to the force of gravity the sensor is permanently immersed in the lubricant or at least brought into contact therewith. Thus a continuous monitoring of the lubricant is also possible.

Additionally or alternatively in a further advantageous embodiment the sensor is formed integrally with a seal of the at least one bearing. According to this exemplary embodiment the lubricant can be monitored inside the bearing itself. A plurality of sensors can also be provided. For example, a sensor can be provided in the hub cover and a sensor can be provided in the seal of the bearing. The display unit here can display the outputs of both sensors.

According to one advantageous exemplary embodiment the display unit has one or more light-emitting diodes for producing an output indicative of the state of the lubricant. Here the output can be effected, for example, in a color-coded manner. A green signal may indicate that the state of the lubricant is still satisfactory; a red signal may indicate that the lubricant must be exchanged. Other colors could also be used, to provide an indication as to the remaining life of the lubricant, for example. Alternatively the light-emitting diode(s) may only illuminate if the lubricant must be exchanged.

The sensor may be configured determine a state or condition of the lubricant in different ways. Furthermore, a plurality of sensors can also be provided that are configured to detect different properties of the lubricant, or a combined sensor can be used that can determine a plurality of properties.

In one advantageous exemplary embodiment the sensor is a temperature sensor configured to produce an output indicative of the temperature of the lubricant. If the temperature of the lubricant reaches or exceeds a predetermined threshold value, for example, this can allow the inference to be drawn that the lubricant has degraded and must be replaced.

Alternatively or additionally the sensor is a capacitive sensor configured to produce a signal indicative of the dielectric conductivity of the lubricant. If the dielectric conductivity or permittivity of the lubricant reaches or exceeds a certain value this mean that too many metal particles are in the lubricant and that the lubricant must be exchanged.

In a further advantageous embodiment the sensor is an ultrasound sensor configured to detect dirt particles in the lubricant using ultrasound. Too many dirt particles means that the lubricant must be exchanged.

Furthermore, in one advantageous exemplary embodiment the sensor can be a magnetic sensor configured to detect the presence of metal particles, for example due to abrasion, in the lubricant.

According to a further aspect of the disclosure a hub cover is proposed that is configured for use in a bearing assembly as described above. The hub cover includes a sensor for monitoring and/or producing a signal indicative of at least one property of a lubricant.

Further advantages and advantageous embodiments are specified in the description, the drawings, and the claims. Here in particular the combinations of features specified in the description and in the drawings are purely exemplary, so that the features can also be present individually or combined in other ways.

In the following the embodiments of the disclosure shall be described in more detail with reference to the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a schematic side elevational view, partly in section, of a bearing assembly according to an embodiment of the present disclosure.

### DETAILED DESCRIPTION

In the following description, identical or functionally equivalent elements are designated by the same reference numbers.

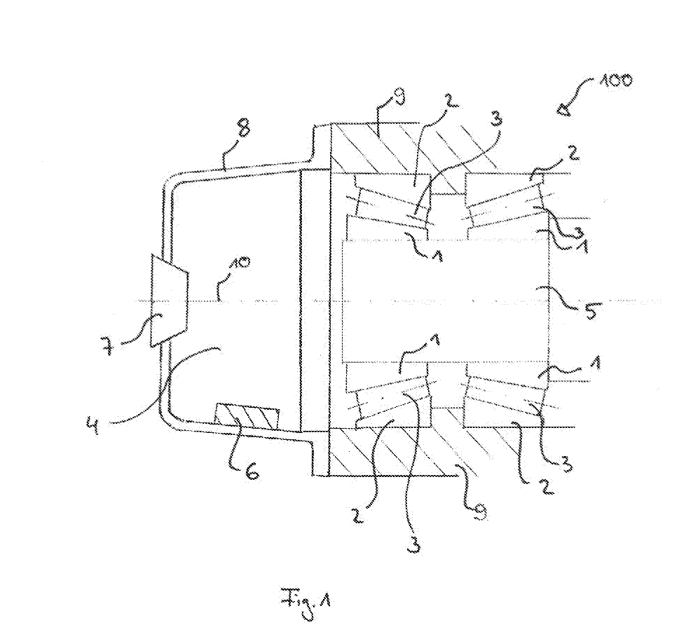

FIG. 1 shows a bearing assembly 100. The bearing assembly 100 may be a wheel bearing assembly for a motor vehicle. In the exemplary embodiment shown in FIG. 1, the bearing assembly includes two bearings, each including a first bearing ring 1 and a second bearing ring 2 that are rotatably disposed relative to each other. The bearings are disposed on an axle 5, and each includes rolling elements 3 between the first bearing ring 1 and the second bearing ring 2. A lubricant 4 is provided in a sealed space that may be referred to as the bearing interior, which space includes the region around the axle 5 and around the bearing including the first bearing ring 1, the second bearing ring 2, and the rolling elements 3. This lubricant is sealed with respect to the outside by a housing 9 and a hub cover 8 which housing 9 and hub cover 8 at least partially define the bearing interior.

The lubricant 4 has a level in the interior indicated by a fill line 10, and due to gravity, is always located in the lower region of the bearing assembly 100. In order to monitor properties of the lubricant 4, a sensor 6 is disposed on or in the hub cover 8. The sensor 6 can be fixedly attached to the hub cover 8 and, when fixedly attached, it will move repeatedly through the lubricant 4 as the bearing assembly 100 rotates. Alternatively the sensor 6 can be disposed such that it is freely movable in the hub cover 8 and thus due to gravity always be located in the lubricant 4.

Alternatively or additionally the sensor 6 can also be disposed on the axle 5 and/or on one of the bearing elements and/or on a seal of the bearing.

The sensor 6 may be configured to detect, for example, a temperature or a dielectric conductivity of the lubricant 4. From these properties it is possible to determine a state of the lubricant 4. This means that based on the detected properties it is possible to determine whether it is necessary to exchange the lubricant 4. In order to make the state of the lubricant 4 knowable from a location outside the bearing interior, a display unit 7 is provided on the hub cover 8. For example, the display unit can include one or more LEDs, the state of which provides an indication as to whether an exchange of the lubricant is required. Only when the display unit 7 indicates that the lubricant 4 must be exchanged is a disassembly of the bearing assembly 100 required, including a removal of the hub cover 8.

Using the bearing assembly 100 described herein it is possible to realize in a simple manner a monitoring of the lubricant 4 present in the bearing assembly 100. For this purpose no disassembly of the bearing assembly 100 is required; rather the state of the lubricant 4 is detected inside the bearing assembly 100 by the sensor 6 and made visible outside by the display unit 7.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing assemblies and associated oil quality sensors.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 First bearing ring
2 Second bearing ring
3 Rolling element
4 Lubricant
5 Axle
6 Sensor
7 Display unit
8 Hub cover
9 Housing
10 Fill line
100 Bearing assembly

1. A wheel bearing assembly for a motor vehicle comprising:
a housing having an interior;
at least one bearing in the interior including a first bearing ring and a second bearing ring rotatably disposed relative to the first bearing ring;
a plurality of rolling elements disposed between the first bearing ring and the second bearing ring;
a lubricant in the housing interior in contact with at least a part of the at least one bearing;
an axle connected to the at least one bearing;
a sensor in the housing interior in contact with the lubricant, the sensor being configured to sense at least one property of the lubricant and to output a signal indicative of the at least one property of the lubricant; and
a display unit outside the housing interior and in communication with the sensor, the display unit being configured to produce an output based on the signal.

2. The bearing assembly according to claim 1, wherein an opening into the housing is closed by a hub cover and wherein the display unit is disposed on or in the hub cover.

3. The bearing assembly according to claim 2, wherein the sensor is disposed on or in the hub cover.

4. The bearing assembly according to claim 2, wherein the hub cover is fixedly attached to the housing and defines a portion of the interior and wherein the lubricant is sealed in the housing by the hub cover.

5. The bearing assembly according to claim 1, wherein the sensor is formed integrally with a seal of the at least one bearing.

6. The bearing assembly according to claim 1, wherein the display unit includes a light-emitting diode and wherein the output comprises light from the light emitting diode.

7. The bearing assembly according to claim 1, wherein the sensor is a temperature sensor.

8. The bearing assembly according to claim 1, wherein the sensor is a capacitance sensor.

9. The bearing assembly according to claim 1, wherein the sensor is an ultrasound sensor.

10. The bearing assembly according to claim 1, wherein the sensor is a magnetic sensor.

11. The bearing assembly according to claim 1,
wherein an opening into the housing is closed by a hub cover,
wherein the display unit is disposed on or in the hub cover,
wherein the sensor is disposed on or in the hub cover,
wherein the hub cover is fixedly attached to the housing and defines a portion of the interior and wherein the lubricant is sealed in the housing by the hub cover, and
wherein the display unit includes a light-emitting diode and wherein the output comprises light from the light emitting diode.

12. A hub cover configured to seal an opening of a bearing housing and define with the bearing housing an interior of a wheel bearing assembly, the hub cover including a sensor configured to sense at least one property of a lubricant contained in the interior and to output a signal indicative of the sensed at least one property.

13. The hub cover according to claim 12, including a display on or in the hub cover configured to produce an output at a location outside the interior based on the signal.

14. The bearing assembly according to claim 1, wherein the sensor is freely movable with respect to the hub cover, such that the sensor is periodically in and periodically out of contact with the lubricant in the interior of the hub cover.

15. The bearing assembly according to claim 1, wherein the sensor is attached to the axle.
